(19) United States
(12) Patent Application Publication
(10) Pub. No.: US 2020/0065783 A1
(43) Pub. Date: Feb. 27, 2020

(54) MULTIPLE CARD PAYMENT PROCESS

(71) Applicant: MASTERCARD INTERNATIONAL INCORPORATED, Purchase, NY (US)

(72) Inventors: Lloyd FERNANDES, Pune (IN); Smita DHARANGUTTE, Pune (IN); Ajad KUSHWAH, Pune (IN)

(21) Appl. No.: 16/109,308

(22) Filed: Aug. 22, 2018

(51) Int. Cl. G06Q 20/10; G06Q 20/40; G06Q 20/20

(52) U.S. Cl. CPC G06Q 20/102; G06Q 20/206; G06Q 20/4093

(57) ABSTRACT

A virtual wallet application and a split services server can support multi-card payment processing using a virtual card. The virtual wallet application can receive a selection of at least two payment cards of two or more payment cards in the virtual wallet application, a corresponding amount for each of the at least two payment cards, and an indication to perform the split payment. In response to receiving the indication to perform the split payment, the virtual wallet application can validate the user and create a transaction request. The transaction request can include the virtual card, tokens of the at least two payment cards and their corresponding portions of the split payment amount, and a split payment flag indicator. The transaction request can be routed by an acquirer to the split services server, which extracts the information of the multiple cards and manages pre-authorization requests to the corresponding issuers.

### BACKGROUND

Payment cards such as credit cards and debit cards are widely used for most forms of financial transactions. The use of payment cards has evolved significantly with technological developments over recent years. Originally, transactions were on paper, using an imprint of a transaction card and confirmed by a signature. This approach was largely replaced by use of a magnetic stripe of a transaction card swiped through a magnetic stripe reader on a point of sale (POS) terminal to perform a transaction. Payment cards developed to contain an integrated circuit (“chip cards” or “smart cards”) that communicates with a smart card reader in the POS terminal. In addition, “virtual” cards have been developed that support mobile payments through the use of tokens and cryptograms.

A payment card user may want to make a purchase using multiple payment cards. Most existing payment and settlement systems support single card operation. That is, each card is separately processed through independent transaction requests to the respective acquirers.

### BRIEF SUMMARY

A multiple card (“multi-card”) payment process is provided. A virtual wallet application is used to register multiple payment cards, which can be used to initiate a transaction on a point of sale terminal or e-commerce web site. Through a virtual card created by the virtual wallet application, a user can supply an amount of payment to be spread across multiple cards. A split services server is provided to receive the payment request from an acquirer based on the routing indicated by the virtual card. The split services server manages the multi-card payment process such that a split payment is possible from a single transaction request.

In some cases, a virtual wallet application, when executed by a computing device, directs the computing device to: register two or more payment cards for a user in the virtual wallet application; generate a virtual card; receive a request for a split payment; and provide, for selection, the two or more payment cards. The virtual wallet application can receive a selection, for the split payment, of at least two payment cards of the two or more payment cards in the virtual wallet application; a corresponding amount for each of the at least two payment cards; and an indication to perform the split payment. In response to receiving the indication to perform the split payment, the virtual wallet application can validate the user; and create a transaction request, wherein the transaction request comprises the virtual card, tokens of the at least two payment cards and the corresponding amount for each of the at least two payment cards, and a split payment flag indicator.

The virtual wallet application can communicate with a split services server to authenticate the virtual card and obtain a split transaction identifier. The split transaction identifier can be included in the transaction request and communicated to a merchant terminal.

In some cases, a split services server can perform a method including: receiving a transaction request that includes a split transaction identifier, a wrapper PAN for a virtual card, tokens of at least two payment cards, corresponding portion amounts of a split payment, and a split payment flag indicator; identifying issuers of the at least two payment cards; generating a sub-transaction identifier for each issuer of each payment card of the at least two payment cards; and requesting pre-authorization for each of the at least two payment cards by communicating to each corresponding issuer a pre-auth request. The pre-auth request includes the sub-transaction identifier and corresponding portion amount of the split payment. The split services server receives a pre-auth result from each issuer; stores the pre-auth result from each issuer and the sub-transaction identifier; and after receiving the pre-auth result from all issuers, generates a pre-auth outcome by determining whether all pre-auth results received from the issuers indicate a successful pre-auth, and communicates the pre-auth outcome to an acquirer.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an operating environment for split payment processing.

FIG. 2 shows an example registration process for adding cards to a virtual card for split payment processing.

FIG. 3 shows an example card selection process for split payment processing.

FIG. 4 shows an example process for creating a split payment request.

FIG. 5 shows processes for split payment services.

FIGS. 6A and 6B show an example process for authorizing payment in a split payment transaction. FIG. 6A illustrates a success case and FIG. 6B illustrates a fail case.

FIG. 7 shows an example process of completion of a split payment transaction.

FIG. 8 shows an example process of reversing a split payment transaction.

FIG. 9 illustrates components of a computing system that may be used in certain embodiments described herein.

### DETAILED DESCRIPTION

A multiple card (“multi-card”) payment process is provided. A virtual wallet application is used to register multiple payment cards, which can be used to initiate a transaction on a point of sale terminal or e-commerce web site. Through a virtual card created by the virtual wallet application, a user can supply an amount of payment to be spread across multiple cards. A split services server is provided to receive the payment request from an acquirer based on the routing indicated by the virtual card. The split services server manages the multi-card payment process such that a split payment is possible from a single transaction request.

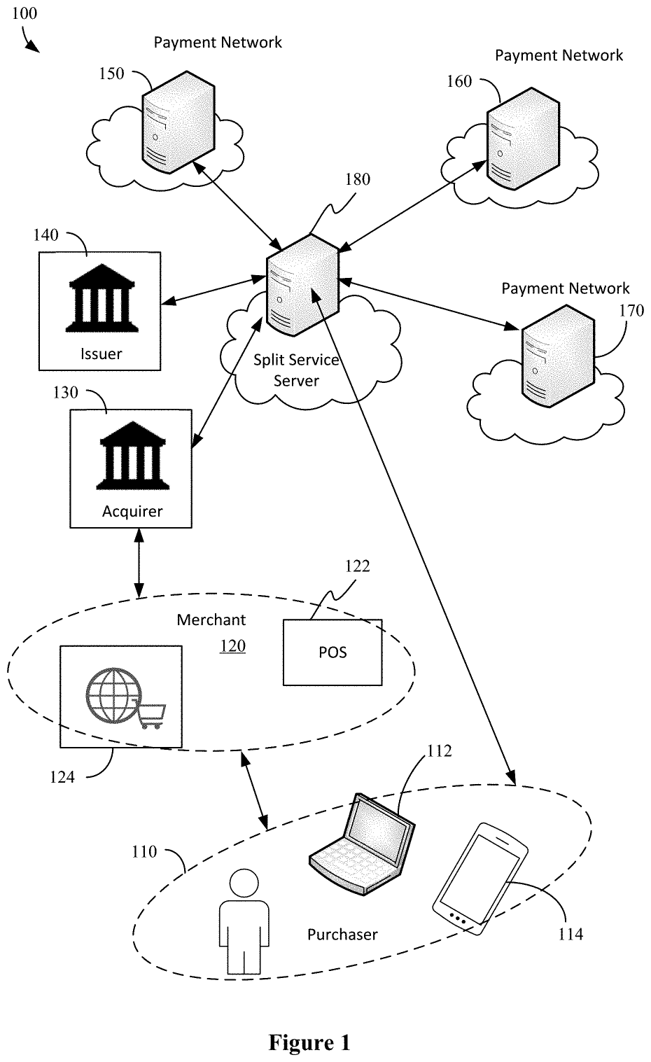

FIG. 1 illustrates an operating environment for split payment processing. Referring to FIG. 1, an operating environment 100 can include a cardholder or purchaser 110, a merchant 120, an acquirer 130 that processes payments on behalf of the merchant 120, at least one issuer 140 providing payment cards to the cardholder 110, and one or more payment networks 150, 160, 170 (and corresponding token service providers) that route transaction information. An example of a payment network is the one operated by Mastercard International Incorporated, the assignee of the present disclosure.

The cardholder 110 makes a request from a merchant 120 to purchase a product or service and provides payment card information and authorization to initiate the transaction. The acquirer 130 receives transactions from the merchant 120 via a payment gateway (e.g., a point of sale (POS) terminal 122 or an online shopping cart or other payment application 124). The acquirer 130 can include a processor that forwards the transaction information to an appropriate payment network. The payment network routes the transaction information to the appropriate issuer 140, which manages and verifies the payment card information, and routes the authorization from the issuer 140 to the acquirer 130. The merchant 120 can complete the transaction via the acquirer 130 in order for the funds to transfer to the merchant's financial institution. In some cases, the same entity can be both the payment network and the issuer.

In some cases, a cardholder 110 uses a physical payment card. However, as used herein, a “payment card” or “card” can also be any non-physical equivalent, such as, for example, a virtual wallet application (also referred to as mobile wallet application) that supports mobile payment via a computing device such as a laptop computer 112, mobile phone 114, and wearable computing devices (e.g., watch or glasses), and similar computing devices.

A virtual wallet application that supports multi-card payments can include instructions, stored on the computing device (e.g., 112, 114), that when executed by a hardware processor of the computing device, create a virtual card for split payment processing, add payment cards (e.g., credit cards and debit cards) to the virtual card, support selection of two or more of the payment cards for use in a split payment, and generate a split payment request.

The described virtual wallet applications supporting a virtual card for a multi-card payment can be stored and executed on any suitable computing device. Computing devices having near-field communication (NFC) capabilities and secure storage (for storing tokens and cryptograms) are used to support payment via POS terminals (that themselves include NFC capabilities). Computing devices without NFC capabilities may be used for online or in-application purchasing or communicate with a proxy or peripheral computing device that has NFC capabilities via wired or wireless communication to perform payment via a POS terminal.

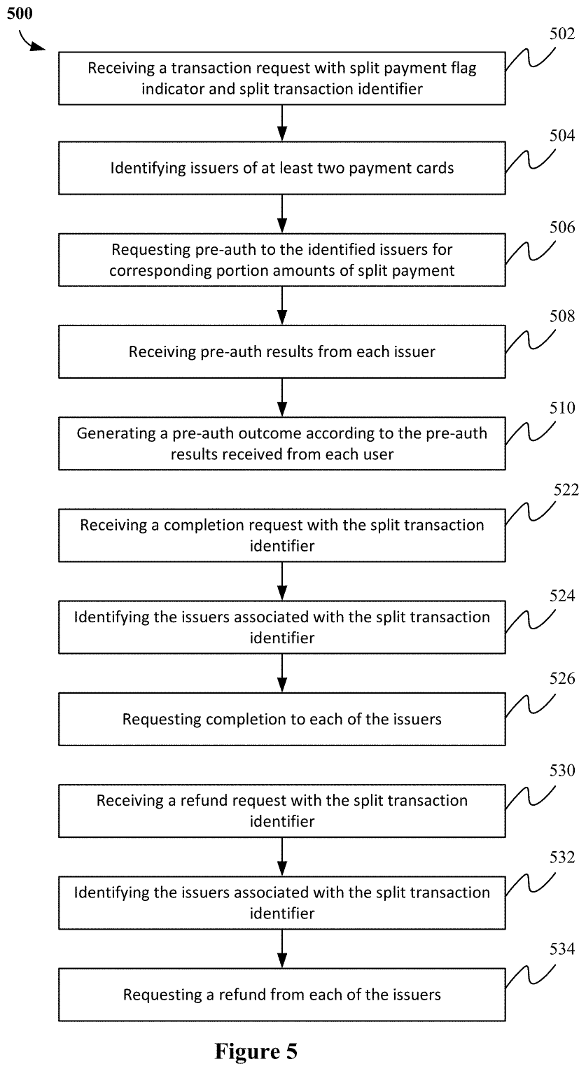

Split payment processing for the multi-card payment can be managed by a split service server 180. The split service server 180 executes instructions for providing the split payment service, including performing processes 500 shown in FIG. 5. The split service server 180 can communicate with the virtual wallet application executing at the cardholder's computing device; one or more payment networks 150, 160, 170 (and corresponding token service providers); and computing systems of acquirer 130 and issuer 140. The communications between these systems may be, for example, via application programming interfaces (APIs).

An API is an interface implemented by a program code component or hardware component (hereinafter “API-implementing component”) that allows a different program code component or hardware component (hereinafter “API-calling component”) to access and use one or more functions, methods, procedures, data structures, classes, and/or other services provided by the API-implementing component. An API can define one or more parameters that are passed between the API-calling component and the API-implementing component. The API is generally a set of programming instructions and standards for enabling two or more applications to communicate with each other and is commonly implemented over the Internet as a set of Hypertext Transfer Protocol (HTTP) request messages and a specified format or structure for response messages according to a REST (Representational state transfer) or SOAP (Simple Object Access Protocol) architecture.

Although the split payment server 180 is shown separate from the payment networks, in some cases, the split payment server 180 may be part of one of the payment networks.

A split service server 180 can manage credentials for the virtual cardholder; and can process virtual card payments as a middle tier between the acquirer 130 and the at least one issuer 140.

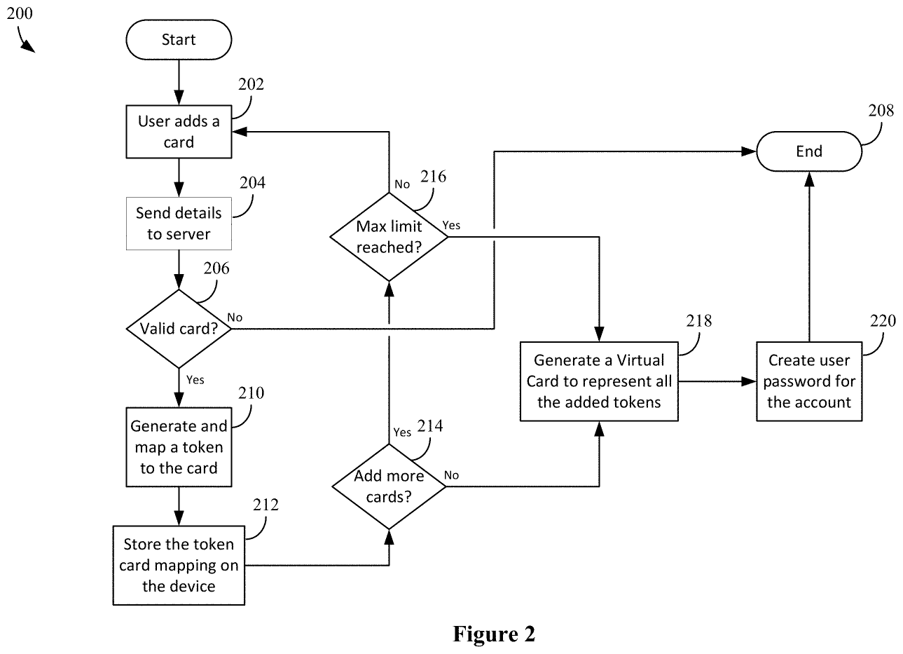

FIG. 2 shows an example registration process for adding cards to a virtual card for split payment processing.

Referring to the multi-card registration process 200 shown in FIG. 2, when a user adds a card (202), the application sends the card details to a validation server (204) and checks if the card is a valid card (206). The validation server can be accessed via a payment network associated with the payment card. The validation server returns the confirmation and if the application receives an indication that the card is not a valid card, registration ends (208). If the application receives an indication that the card is a valid card, the application generates a token to associate with the card (210); and stores the token on the device (212).

The process of generating the token can be carried out as known in the art. For example, when a credit or debit card is added to the Payment/Virtual Wallet application, the application requests a token, from the bank that issued the card, to represent the card. For example, the application can send the card number, or “primary account number” (PAN), to the cardholder's issuing bank. The issuing bank can return an alias PAN, which represents the original PAN, but can be used in place of the original PAN for additional security. A token service provider may be used to map tokens to funding PANs (the underlying PAN used/understood by the issuer).

Once the token is issued the card is considered “tokenized,” meaning it has a unique identification number associated with it. The application can encrypt the newly tokenized card and store the token/PAN in a secure device storage with a corresponding cryptogram. The application can generate the cryptogram for each card via any suitable process. A cryptogram is a limited-use (LUK) or single key (SUK) password that joins/associates the token with the customer's actual card number.

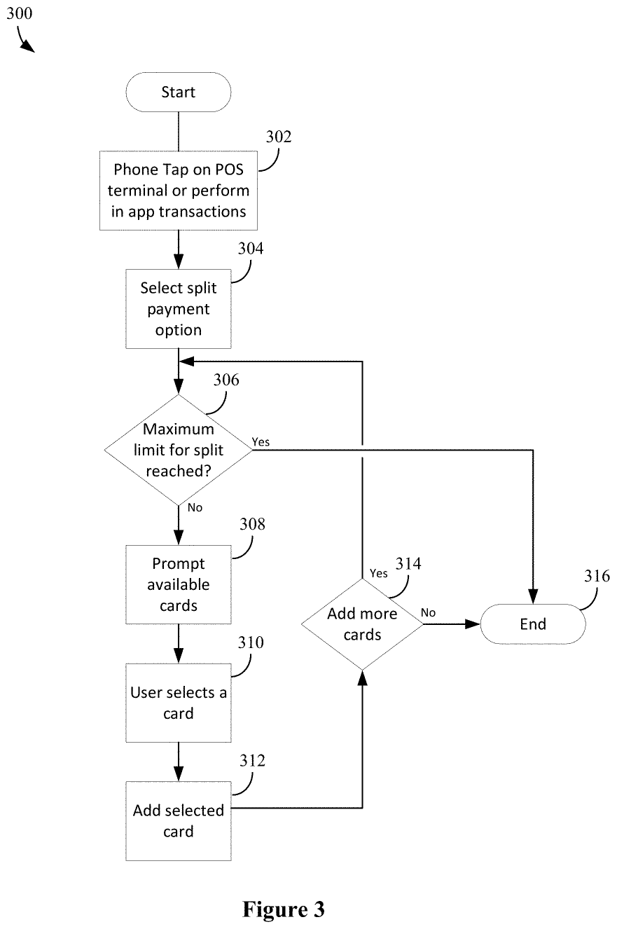

For applications that generate tokens at the time a transaction is initiated, the generation of the token may be carried out at the time of the payment request creation as described with respect to FIG. 3.

As the user adds cards, the application can determine whether a maximum number of cards that can be registered has been reached. After the application determines (214) that the user has finished adding cards or determines (216) that the maximum number of cards that can be reached, the application can generate a virtual card to represent all the added cards (218). The virtual card can be generated by communicating with the split service server to generate a PAN, referred to herein as a “wrapper PAN,” for the virtual card. The wrapper PAN identifies the network (e.g., the split service server) with which to send the transaction message to. The split service server on the identified network recognizes the wrapper PAN as representing a split payment and processes the tokens sent with the wrapper PAN. The virtual card may be “tokenized” in a similar manner as the payment cards. In some cases, the virtual card can be a static card that is fixed for an application (e.g., there is no dynamic “generating” of the virtual card; rather the virtual card token can be considered to be active once all the cards are added to the virtual card of the application).

For later access to the virtual card, the application can prompt the user to create a user password for the account (220). The password may be, for example, a PIN (e.g., a numeric or alpha-numeric password) or a biometric (e.g., retina, facial recognition, fingerprint) and used to authenticate the cardholder.

The split service server can generate the wrapper PAN in response to receiving a request for a new virtual card from operation 218 and also establish the credentials for the cardholder. The new virtual card can be provided with a wrapper PAN, expiry information, and a card verification value.

FIG. 3 shows an example card selection process for split payment processing.

As previously mentioned, the virtual card represents the cards that have been added and can include the token and cryptogram for each card. When payment is initiated, tokens (and corresponding cryptograms) of the selected cards are “deposited” in the virtual card, which has its own token (the wrapper PAN).

The card selection process (300) may begin when a customer makes a purchase, for example by tapping their mobile device on a POS terminal or paying within a mobile app. The application receives an indication that a POS terminal or in-application transaction is to be initiated (302).

In regular payment mode using a single card, the application responds to the purchase request from the customer by providing the customer's tokenized card and a cryptogram, which acts as a one-time use password. The card network validates the cryptogram and matches the token with the customer's actual card number.

However, for the described multi-card payment system, the application responds to the purchase request (e.g., the indication of a POS terminal or in-application transaction initiation), by providing a split payment option.

When selection of the split payment option is received (304), the application can check to determine (306) if the maximum limit for a split has been reached; and if not, then prompt the user with available cards that were registered to the virtual card (308).

The application can receive a user's selection of a card (310) and then add the selected card to be used with the virtual card (312). Additional cards can be added until the maximum limit for the split is reached. After the application determines that the user has finished adding cards (314) or determines (306) that the maximum limit for the split is reached, the selection process ends (316).

The maximum limit in the number of cards for a split can be fewer cards than what is permitted to be registered. In some cases, the maximum limit for a split can be based on the constraints (e.g., desired, permissible, or available transaction speeds) for the network. For example, the maximum limit for a split may be three cards in order to enable the portion of the transaction managing the split payment to be completed over the payment process network within 5 ms. As faster speeds and larger bandwidths become available, more cards may be included in a multi-card payment.

After the cards to be used for the multi-card payment are selected, a payment request can be created.

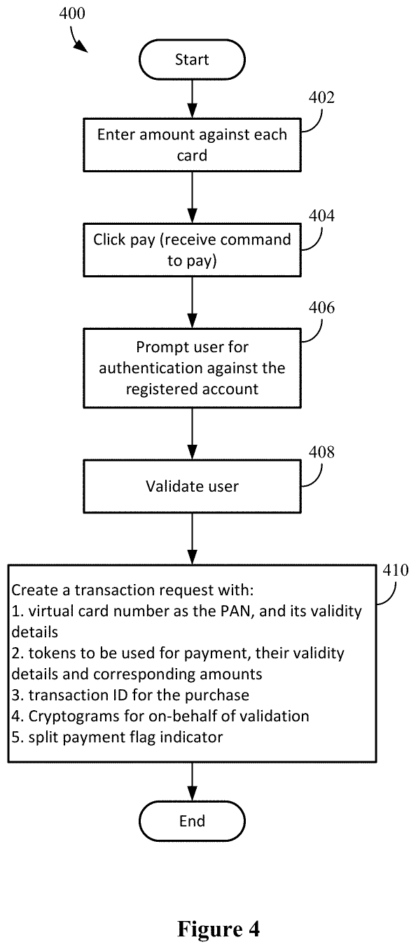

FIG. 4 shows an example process for creating a split payment request. Referring to FIG. 4, a process 400 can begin based on the cards selected from process 300 described with respect to FIG. 3. For each selected card, an amount is received to be entered against each card (402) and a command to complete payment is received (404).

At the time of payment initiation (e.g., clicking pay), the user is prompted for their authentication against the registered account (406); and the user is validated (408). In some cases, instead of at the completion of receiving details for the split payment from the cardholder, the application may prompt the user for the password prior to providing the split payment option (e.g., prior to operation 304 in FIG. 3).

Once validation is completed and the details for the amount of payment and selected payment cards are received, the application can create the payment request message (410). The payment request message can be created by taking the wrapper PAN as the token for the message (e.g., the bank information number) and then the tokens corresponding to the selected payment cards to be used for payment, their validity details (e.g., expiry, CVV), corresponding amounts of payments and cryptograms for on-behalf of validation can be provided as part of the message body, for example, in fields of the message structure, along with a split payment flag indicator. The split payment flag indicator can be implemented using any suitable field of the message data structure that can be understood to indicate that the transaction is a split payment. In some cases, the split payment flag indicates a number of payment cards for the split payment (e.g., by using a value or string). A split transaction identifier, which may have been provided to the application by the split service server at the time of authentication, is also included as part of the message.

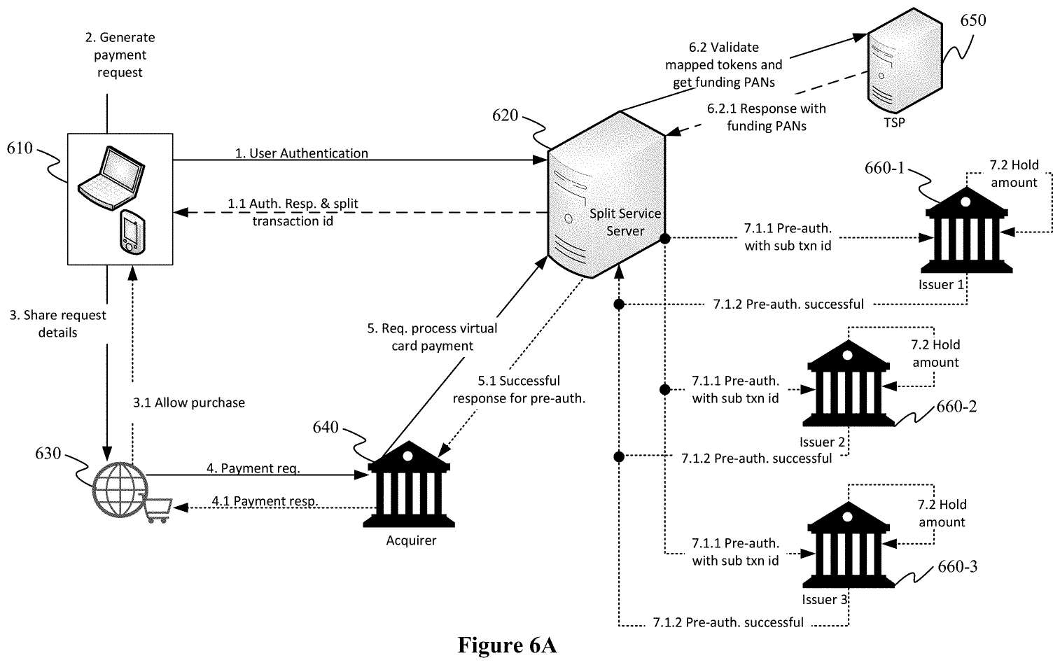

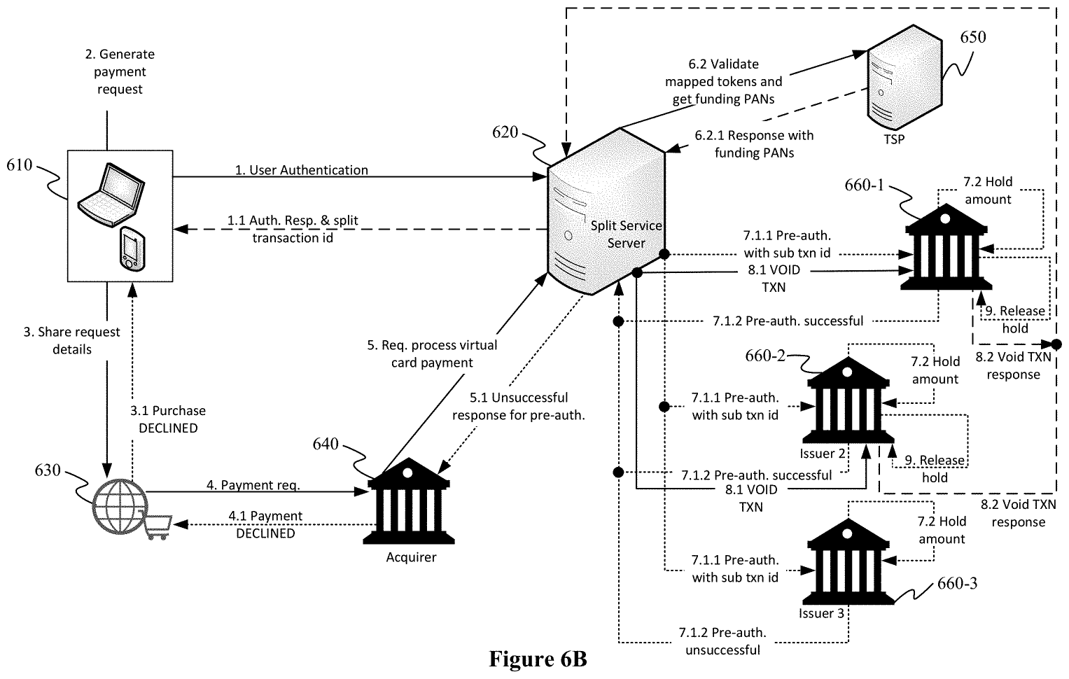

Returning briefly to FIG. 1, once the payment request message is created, the payment request message can be transmitted from the user's computing device (e.g., 112, 114 of FIG. 1) to the merchant terminal (e.g., 122, 124 of FIG. 1) and then to the acquirer (e.g., 130 of FIG. 1). As will be described in more detail with respect to FIGS. 6-8, because message includes a split flag, the acquirer knows that the transaction will perform multiple card transactions and that the transaction will end in two legs. In addition, the split payment request indicates that the request is for pre-authorization (“pre-auth”) processing. That is, the payment cards—both credit and debit cards—are processed for pre-authorization.

A credit card pre-auth is a temporary hold on the funds that last for a period of time (e.g., 5 days). During the temporary hold, the cardholder cannot spend the money anywhere else, but the charge may not actually show up on their credit card statement. Within the time period of the temporary hold, the merchant must go in and “capture” the funds or else the pre-authorization expires and the funds are released by the card issuing bank back to the cardholder. Because pre-authorizations are not settlements and are not shown as charges on the cardholder's card, the cardholder cannot dispute the transaction or issue a chargeback (e.g., receive a refund). Generally, in order to perform credit card pre-authorization, the transactions must indicate that the transaction is a pre-authorization. The indication is possible when using a credit card processor/payment gateway that supports pre-authorizations and a terminal/online shopping cart that can send transactions to the gateway that are formatted to use a pre-authorization. Once the hold has been reserved on the funds, the funds can be captured by indicating to the payment processor, via some merchant interface, that the pre-authorization is ready to be converted into a full authorization.

A debit card pre-auth is similar to a credit card pre-auth except that the amount placed on hold is removed from the cardholder's available bank balance and the cardholder can typically see that the funds are on hold. Holds are typically released when the transaction clears the cardholder's account or a period of time from the original transaction time.

The virtual card number is read by the acquirer and routed to the split service server (e.g., 180 of FIG. 1).

FIG. 5 shows processes for split payment services. Processes (500) carried out by the split services server can include receiving (502) a transaction request. The transaction request can be identified as being for a split payment by the split payment flag indicator with the request. The transaction request can include a split transaction identifier, a wrapper PAN for a virtual card, tokens of at least two payment cards, corresponding portion amounts of a split payment, and a split payment flag indicator.

The server can identify (504) issuers of the at least two payment cards. For example, the split services server can read the split payment flag indicator to determine the number of payment cards for the split payment and use that number to extract the appropriate tokens and other information such as expiry and corresponding payment amounts. In some cases, the server extracts the tokens (which may be in the form of a token BIN—bank identification number), validates each token using its corresponding cryptogram, and obtains funding PANs associated with the tokens. The validating and obtaining funding PANs may be carried out by a token service provider associated with the appropriate payment network (e.g., 150, 160, 170 of FIG. 1). The extracted and obtained/fetched information can be stored at the split services server.

The processes 500 can continue with requesting (506) pre-auth to the identified issuers for corresponding portion amounts of the split payment. The pre-auth request can be performed by generating a sub-transaction identifier for each issuer of each payment card of the at least two payment cards; and requesting pre-authorization for each of the at least two payment cards by communicating to each corresponding issuer a pre-auth request. Each pre-auth request includes the sub-transaction identifier and corresponding portion amount of the split payment. The sub-transaction identifiers can be stored at the split services associated with the original split transaction identifier.

The split services server waits to receive (508) a pre-auth result from each issuer; and then generates (510) a pre-auth outcome according to the pre-auth results received from each user. The server gathers responses from all of the tokens and does not communicate to the acquirer until responses have been obtained from all of the issuers.

For example, the split services server can store the pre-auth result from each issuer and the sub-transaction identifier; and after receiving the pre-auth result from all issuers, generate the pre-auth outcome by determining whether all pre-auth results received from the issuers indicate a successful pre-auth. The pre-auth outcome covering all issuers can be communicated to an acquirer in a single message. If all pre-auth results received from the issuers indicate the successful pre-auth, the pre-auth outcome communicated to the acquirer is an indication of a successful response for pre-auth. However, if one or more of the pre-auth results received from the issuers indicates an un-successful pre-auth, the split services server voids the pre-auth at issuer that responded indicating a successful pre-auth. In addition, in such a case the pre-auth outcome communicated to the acquirer is an indication of an unsuccessful response for pre-auth. The communication can further include which payment card token failed.

Because the sub-transaction identifiers may be stored associated with the original split transaction identifier, completion requests and refund requests containing the split transaction identifier can identify appropriate issuers and manage the multiple card activities.

In some cases, processes (500) include receiving a completion request with the split transaction identifier (522), identifying the issuers associated with the split transaction identifier (524); and requesting completion to each of the issuers (526).

In some cases, processes (500) include receiving a refund request with the split transaction identifier (530) identifying the issuers associated with the split transaction identifier (532); and communicating requests for refunds to each issuer (534).

FIGS. 6A and 6B show an example process for authorizing payment in a split payment transaction. FIG. 6A illustrates a success case and FIG. 6B illustrates a fail case.

Referring to both FIG. 6A and FIG. 6B, as mentioned with respect to FIGS. 3 and 4, when a purchaser selects to make a multi-card payment for a purchase, the virtual wallet application communicates (via computing device 610) to the split service server 620 for user authentication (communication 1) and receives an authentication response and split transaction identifier (communication 1.1) that is used to generate the payment request (step 2), which is communicated to the merchant 630 (communication 3) and transmitted to the acquirer 640 (communication 4).

Based on the split payment flag indicator, the acquirer 640 will know that the transaction will perform multiple card transactions, and will also be aware that the transaction will end in two legs. The acquirer 640 uses the wrapper PAN (the virtual card number) to route the transaction to the split service server 620 (communication 5). As described with respect to FIG. 4, the message includes the wrapper PAN, the multiple tokens and their corresponding cryptograms and amounts.

The split service server 620 can perform processes such as described with respect to processes 500 of FIG. 5. The server 620 handles a single token validation—for the wrapper PAN. The split service server 620 can extract the tokens and validate the tokens using the corresponding cryptograms. For example, if the message includes the split flag indicator, the server 620 can read a field in the message indicating a number of tokens in the virtual card, and then read out the number of fields indicated by the number of tokens to obtain the selected tokens and corresponding cryptograms for the split payment. The split service server 620 can use third party service providers (e.g., via token service provider or TSP 650) to validate tokens that the server is not capable to validate (communication 6.2). The token service providers 650 map the token/cryptogram to an associated funding PAN (and issuer). Validated tokens are used to fetch the corresponding funding PANs and expiry date mapped to each token.

The split service server 620 receives the funding PANs from an internal provider or TSP 650 (e.g., communication 6.2.1) and communicates with the associated issuers 660-1, 660-2, 660-3 to obtain pre-authorization.

For example, based on each funding PAN, the server 620 identifies the issuer, and generates an individual transaction for each issuer 660-1, 660-2, 660-3 (communicated to issuers as communications 7.1.1). Each of these transactions can have a unique sub-transaction identifier. The original transaction identifier can be maintained in the messages, but the sub-transaction identifier is used to track which transaction, if any, failed. Each issuer 660-1, 660-2, 660-3 validates the card (funding PAN) of its transaction, performs a hold of an amount indicated by the transaction (communication 7.2), and sends a pre-auth response back to the split service server 620 (communication 7.1.2).

As shown in FIG. 6A, when all pre-auth requests are returned with pre-auth successful responses, the split service server 620 communicates a successful response for pre-auth to the acquirer 640 (communication 5.1), which provides the payment response to the merchant 630 (communication 4.1), who indicates that the purchase was allowed to the purchaser (communication 3.1).

However, as shown in FIG. 6B, when one or more of the pre-auth requests are returned with pre-auth fail responses (e.g., pre-auth un-successful response communication 7.1.2), the split service server 620 communicates with the other issuers (who provided a pre-auth successful response) to void the transaction. For example, issuers 660-1 and 660-2 returned a pre-auth successful response, but issuer 660-3 did not. Thus, the split service server 620 communicates with issuers 660-1 and 660-2 to void their transactions (communication 8.1). The issuers 660-1 and 660-2 can confirm the void (e.g., void TXN response in communication 8.2); and at this point (step 9), the issuers 660-1 and 660-2 release the hold of the transaction amount that was placed in communication 7.2.

Advantageously, the voiding of the transaction can be done before communicating the individual responses to the acquirer 640. Instead, a single un-successful pre-auth response (a “decline” message) can be communicated to the acquirer 640 (during communication 5.1).

A void transaction is a debit or credit card purchase that is canceled after it has been authorized but before it has been settled. A void transaction is different from a refund. In a void transaction, no funds are ever actually transferred from the customer's payment account to the merchant. If a payment processing system settles transactions immediately, the seller would have to issue a refund rather than void the transaction.

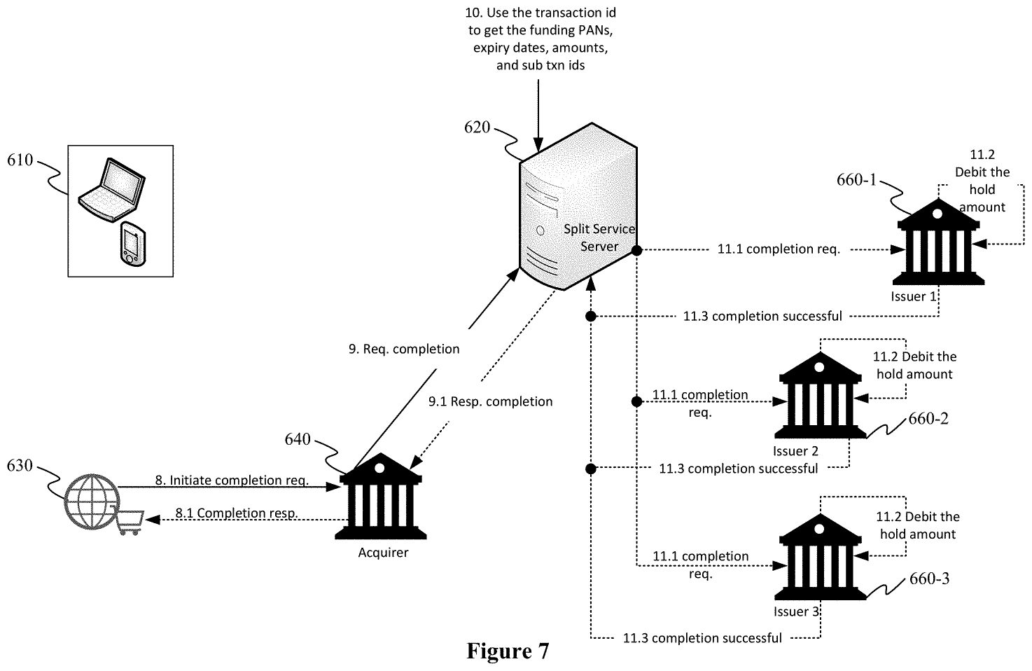

FIG. 7 shows an example process of completion of a split payment transaction. Referring to FIG. 7, completion can be initiated by the merchant 630, for example, through a merchant interface, by submitting a completion request (communication 8) to the acquirer 640. Typically, a merchant requests completion in batches. The completion request includes the transaction identifier for the transaction to be completed. The acquirer 640 routes the completion request for that particular transaction identifier to the split services server 620 (communication 9). In response to receiving a completion request, the split services server 620 uses the transaction identifier to get funding PANs, expiry dates, amounts, and sub-transaction identifiers (step 10); and communicates completion requests to each issuer 660-1, 660-2, 660-3 (communications 11.1). The issuers 660-1, 660-2, 660-3 debit the hold amount (communication 11.2) and respond to the split servicers server 620 that completion was successful (communication 11.3). Once all sub-transactions are found to have successful completion, the split service server 620 can communicate a completion response (communication 9.1) to the acquirer 640, who then provides the completion response to the merchant 630 (communication 8.1).

In some cases, a user wants to cancel the transaction or return a product. In the case that the pre-auth was successful and the user returns the product before completion, the merchant just does not initiate a completion request, so the hold will be released after the specified hold period for the card. In the case that completion already occurred, the merchant can initiate a refund request.

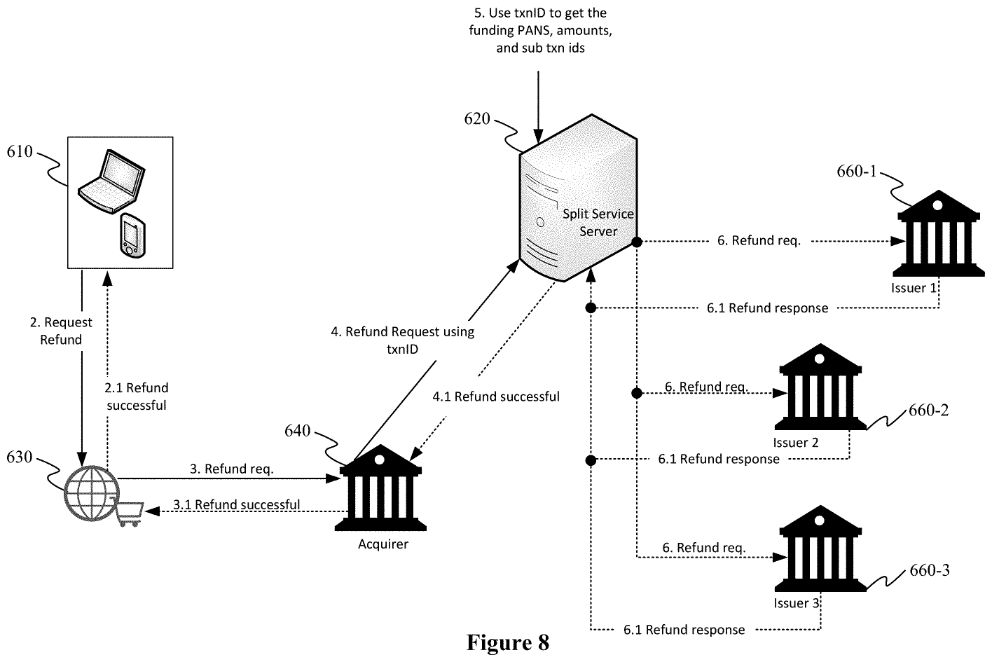

FIG. 8 shows an example process of reversing a split payment transaction. Referring to FIG. 8, a user can initiate a return by requesting a refund from the merchant 630 (communication 2). For example, the user may return an item to a merchant to request that the amount they paid is returned back to the user's issuer. Since the merchant has already had a successful completion of the transaction, the merchant 630 can send a refund request (communication 3) to the acquirer 640. The refund request includes the transaction identifier (txnID) for the purchase. The acquirer 640 then routes the refund request to the split service server 620 using the transaction identifier (communication 4). The split service server 620 can use the transaction identifier to identify the banks/issuers associated with the transactions, for example by getting the funding PANs and sub-transaction identifiers (step 5), and using that information to communicate to the appropriate issuers 660-1, 660-2, 660-3 to request a refund (communication 6). A refund response can be returned to the split service server 620 (communication 6.1) and the split service server 620 can inform the acquirer 640 (communication 4.1) of a successful refund after all the issuers have returned their refund responses.

As part of the multi-card payment process, transactions can be mandated for pre-auth so the amount is always kept on hold with the issuers. Thus, in case of cancellations and refunds where the completion request has not yet been sent to the issuer, no amount has to flow back between the issuer and the acquirer.

As illustrated by the above examples, instead of requiring multiple requests for each card, a single transaction request is sent for multiple cards using a token for multiple tokens. Advantageously, fewer transaction steps and less use of network resources/overhead are required for an acquirer. Moreover, no change is required in the infrastructure for acquirer, issuer or merchant. Rather, the split service server handles the unpacking of tokens and communicates with different issuers.

In current payment transactions using multiple cards, if authorization fails for one of the cards, the transaction would have to be cancelled. Further the acquirer would need to initiate multiple adjustments with the issuers, increasing the load on the acquirer. By using the described split payment processing, the overhead on the networks and acquirer systems can be reduced. In addition, if a pre-auth fails for an issuer, the split services server can send a void transaction request to release the hold immediately, which can minimize the amount of time that the user's funds would be placed on hold in the case that multi-card payment would not be able to be rendered.

In some cases, the described techniques may be built over features provided by the particular wallet provider. For example, for wallets that maintain a card on file, a user will not have to store their card with the merchant/website.

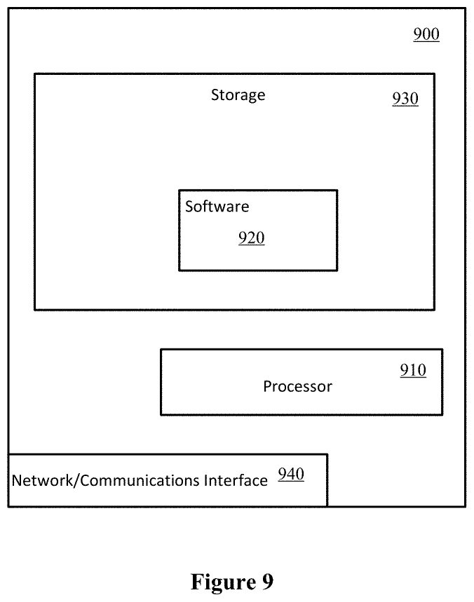

FIG. 9 illustrates components of a computing system that may be used in certain embodiments described herein. Referring to FIG. 9, system 900 may be implemented within a single computing device or distributed across multiple computing devices or sub-systems that cooperate in executing program instructions. The system 900 can include one or more blade server devices, standalone server devices, personal computers, routers, hubs, switches, bridges, firewall devices, intrusion detection devices, mainframe computers, network-attached storage devices, and other types of computing devices. The system hardware can be configured according to any suitable computer architectures such as a Symmetric Multi-Processing (SMP) architecture or a Non-Uniform Memory Access (NUMA) architecture.

The system 900 can include a processing system 910, which may include one or more processors and/or other circuitry that retrieves and executes software 920 from storage system 930. Processing system 910 may be implemented within a single processing device but may also be distributed across multiple processing devices or sub-systems that cooperate in executing program instructions.

Storage system(s) 930 can include any computer readable storage media readable by processing system 910 and capable of storing software 920. Storage system 930 may be implemented as a single storage device but may also be implemented across multiple storage devices or sub-systems co-located or distributed relative to each other. Storage system 930 may include additional elements, such as a controller, capable of communicating with processing system 910. Storage system 930 may also include storage devices and/or sub-systems on which data is stored. System 900 may access one or more storage resources in order to access information to carry out any of the processes indicated by software 920.

Software 920, including routines for performing processes such as processes 500 for the split service server may be implemented in program instructions and among other functions may, when executed by system 900 in general or processing system 910 in particular, direct the system 900 or processing system 910 to operate as described herein.

In embodiments where the system 900 includes multiple computing devices, the server can include one or more communications networks that facilitate communication among the computing devices. For example, the one or more communications networks can include a local or wide area network that facilitates communication among the computing devices. One or more direct communication links can be included between the computing devices. In addition, in some cases, the computing devices can be installed at geographically distributed locations. In other cases, the multiple computing devices can be installed at a single geographic location, such as a server farm or an office.

A communication interface 940 may be included, providing communication connections and devices that allow for communication between system 900 and other computing systems (not shown) over a communication network or collection of networks (not shown) or the air.

In some embodiments, system 900 may host one or more virtual machines.

Alternatively, or in addition, the functionality, methods and processes described herein can be implemented, at least in part, by one or more hardware modules (or logic components). For example, the hardware modules can include, but are not limited to, application-specific integrated circuit (ASIC) chips, field programmable gate arrays (FPGAs), system-on-a-chip (SoC) systems, complex programmable logic devices (CPLDs) and other programmable logic devices now known or later developed. When the hardware modules are activated, the hardware modules perform the functionality, methods and processes included within the hardware modules.

It should be understood that as used herein, in no case do the terms “storage media,” “computer-readable storage media” or “computer-readable storage medium” consist of transitory carrier waves or propagating signals. Instead, “storage” media refers to non-transitory media.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A computing device comprising:
a processor;
a storage device;
a virtual wallet application having instructions stored in the storage device that when executed by the processor, direct the computing device to:
register two or more payment cards for a user in the virtual wallet application;
generate a virtual card;
receive a request for a split payment;
provide, for selection, the two or more payment cards;
receive a selection, for the split payment, of at least two payment cards of the two or more payment cards in the virtual wallet application; a corresponding amount for each of the at least two payment cards; and an indication to perform the split payment;
in response to receiving the indication to perform the split payment, validate the user; and create a transaction request, wherein the transaction request comprises the virtual card, tokens of the at least two payment cards and the corresponding amount for each of the at least two payment cards, and a split payment flag indicator.

2. The computing device of claim 1, wherein the instructions to generate the virtual card direct the computing device to:
communicate with a split service server to generate a wrapper PAN for the virtual card and establish credentials including a user password for the user.

3. The computing device of claim 1, wherein the instructions to create the transaction request direct the computing device to:
assign the wrapper PAN as a bank information number for the transaction request;
provide the tokens of the at least two payment cards, their expiry, the corresponding amount for each of the at least two payment cards, and their cryptograms in a message body of the transaction request; and
set the split payment flag indicator.

4. The computing device of claim 1, wherein the split payment flag indicator indicates a number of payment cards for the split payment.

5. The computing device of claim 1, wherein the virtual wallet application further comprises instructions that direct the computing device to:
communicate with a split services server to authenticate the virtual card and obtain a split transaction identifier, wherein the split transaction identifier is included in the transaction request.

6. The computing device of claim 1, wherein the virtual wallet application further directs the computing device to communicate the transaction request to a merchant terminal.

7. The computing device of claim 6, wherein the merchant terminal is a point of sale terminal or e-commerce website.

8. One or more computer-readable storage media having instructions for a split payment service stored thereon that when executed, direct a processing system to:
receive a transaction request comprising a split transaction identifier, a wrapper PAN for a virtual card, tokens of at least two payment cards, corresponding portion amounts of a split payment, and a split payment flag indicator;
identify issuers of the at least two payment cards;
generate a sub-transaction identifier for each issuer of each payment card of the at least two payment cards;
request pre-authorization for each of the at least two payment cards by communicating to each corresponding issuer a pre-auth request, wherein the pre-auth request comprises the sub-transaction identifier and corresponding portion amount of the split payment;
receive a pre-auth result from each issuer;
store the pre-auth result from each issuer and the sub-transaction identifier; and
after receiving the pre-auth result from all issuers, generate a pre-auth outcome by determining whether all pre-auth results received from the issuers indicate a successful pre-auth, and communicate the pre-auth outcome to an acquirer.

9. The media of claim 8, wherein the instructions to identify issuers of the at least two payment cards direct the processing system:
extract each token of the at least two payment cards;
validate the token; and
fetch a funding PAN corresponding to the token.

10. The media of claim 9, wherein the number of payment cards are indicated by the split payment flag indicator.

11. The media of claim 9, wherein the instructions to validate the token and fetch the funding PAN direct the processing system to communicate with a token service provider that performs validation and fetching.

12. The media of claim 11, wherein the instructions to validate the token and fetch the funding PAN direct the processing system to communicate at least the token, expiry, and a cryptogram to the token service provider, the expiry and the cryptogram being extracted from the transaction request with the token.

13. The media of claim 8, wherein in response to the instructions that direct the processing system to determine whether all pre-auth results received from the issuers indicate the successful pre-auth determining that one or more of the pre-auth results received from the issuers indicates an un-successful pre-auth, the instructions further direct the processing system to:
communicate a void transaction to each issuer that responded indicating a successful pre-auth,
wherein the pre-auth outcome communicated to the acquirer is an indication of an unsuccessful response for pre-auth and which payment card token failed.

14. The media of claim 8, wherein in response to the instructions that direct the processing system to determine whether all pre-auth results received from the issuers indicate the successful pre-auth determining that all pre-auth results received from the issuers indicate the successful pre-auth, the pre-auth outcome communicated to the acquirer is an indication of a successful response for pre-auth.

15. The media of claim 8, further comprising instructions that direct the processing system to:
receive a completion request comprising the split transaction identifier; and
in response to the completion request, use the split transaction identifier to identify the issuers of the at least two payment cards and the sub-transaction identifiers; and communicate completion requests to each issuer.

16. The media of claim 15, further comprising instructions that direct the processing system to:
receive a refund request comprising the split transaction identifier;
in response to the refund request after the completion request, use the split transaction identifier to identify the issuers of the at least two payment cards and the sub-transaction identifiers; and communicate requests for refunds to each issuer.

17. The media of claim 8, further comprising instructions that direct the processing system to:
receive a request to generate a virtual card for a virtual wallet application of a user;
generate a wrapper PAN for the virtual card;
establish credentials including a user password for the user;
authenticate the virtual card using the user password;
generate the split transaction identifier; and
communicate the split transaction identifier to the virtual wallet application.

18. A method comprising:
receiving, at a merchant terminal, a transaction message comprising a wrapper PAN, a split flag indicator, and transaction information, including a split transaction identifier, from a virtual wallet application supporting a virtual card for multi-card payments;
receiving, at an acquirer, the transaction message from the merchant terminal;
routing, by the acquirer, the transaction message to a split services server based on the wrapper PAN;
receiving, at the split services server, the transaction message;
identifying, from the transaction message, by the split services server, issuers of at least two payment cards and corresponding portion amounts of a split payment;
generating, by the split services server, a sub-transaction identifier for each issuer of each payment card of the at least two payment cards;
requesting pre-authorization for each of the at least two payment cards by communicating from the split services server to each corresponding issuer a pre-auth request, wherein the pre-auth request comprises the sub-transaction identifier and corresponding portion amount of the split payment;
receiving, at the split services server, a pre-auth result from each issuer;
storing the pre-auth result from each issuer and the sub-transaction identifier; and
after receiving the pre-auth result from all issuers, generating a pre-auth outcome by determining whether all pre-auth results received from the issuers indicate a successful pre-auth, and communicating the pre-auth outcome to an acquirer,
wherein if all pre-auth results received from the issuers indicate the successful pre-auth, the pre-auth outcome communicated to the acquirer is an indication of a successful response for pre-auth; and if one or more of the pre-auth results received from the issuers indicates an un-successful pre-auth, communicating a void transaction from the split services server to each issuer that responded indicating a successful pre-auth, wherein the pre-auth outcome communicated to the acquirer is an indication of an unsuccessful response for pre-auth.

19. The method of claim 18, wherein the identifying of the issuers comprises:
extracting each token of the at least two payment cards, the number of payment cards being indicated by the split payment flag indicator;
validating the token; and
fetching a funding PAN corresponding to the token.

20. The method of claim 18, further comprising, at the split services server:
in response to receiving a completion request comprising the split transaction identifier, using the split transaction identifier to identify the issuers of the at least two payment cards and the sub-transaction identifiers; and communicating completion requests to each issuer.
in response to receiving a refund request after receiving the completion request, wherein the refund request comprises the split transaction identifier, using the split transaction identifier to identify the issuers of the at least two payment cards and the sub-transaction identifiers; and communicating requests for refunds to each issuer.
